(19) United States
(12) Patent Application Publication
(10) Pub. No.: US 2025/0218272 A1
(43) Pub. Date: Jul. 3, 2025

(54) METHOD FOR ENSURING USABLE AUDIO RECORDING OF HUMAN SPEECH BY ALERTING OR MARKING UNUSABLE PORTIONS

(71) Applicant: Darren Bean, SALINAS, CA (US)

(72) Inventor: Darren Bean, SALINAS, CA (US)

(21) Appl. No.: 18/400,257

(22) Filed: Dec. 29, 2023

(51) Int. Cl. G08B 21/18; G11B 27/031

(52) U.S. Cl. CPC G08B 21/182; G11B 27/031

(57) ABSTRACT

A method for ensuring usable (intelligible or transcribable) audio recording of human speech for record keeping purposes by alerting in real-time when an incoming audio signal or portion of audio recording will not be usable for its intended purpose, or marking in real-time or near real-time portions of an audio recording likely unusable for its intended purpose; in some embodiments, the invention uses algorithms or trained artificial intelligence models to identify unusable portions; an article embodying the preceding using one or more microprocessors.

### CROSS-REFERENCE TO RELATED APPLICATIONS

This application claims the benefit of U.S. Provisional Patent Application No. 63/488,996, filed Mar. 8, 2023, which is incorporated by reference herein in its entirety.

### INTRODUCTION

Those skilled in the art will recognize embodiments beyond the descriptions contained herein. Preferred embodiments and examples are not intended to be limiting.

As used in this application, “alert” or “alerting” refers to a real-time indicator, such as a red light or audio signal, that would allow a person to promptly recognize that an error has occurred.

“Mark” or “marking” refers to a non-real-time indicator depicting a section of input, either using a range of values (such as a timestamp or output of timestamp ranges) or marking a portion of a waveform or text output, via highlighting or a similar method of visual distinction.

“Participant” refers to a person who may make any contribution to the audio being recorded, by either providing statements, commentary, questions, answers, by supervising, directing, controlling, or guiding other participants or the audio recording process, or any combination of these.

“Usable” in the context of a portion of an audio recording of human speech refers to a portion of the recording where the human speech is intelligible or transcribable, such that the audio recording suffices as a record of what was said. “Unusable” refers to a portion that is not “usable.”

“Audio input” refers to captured audio, which may be recorded in real-time, stored in a file, or transmitted over a network.

### BACKGROUND OF THE INVENTION

The invention relates to the field of real-time error alerts, and error marking in real-time or near real-time, of portions of an audio recording of human speech that is intended to be used as a record of words spoken, when a portion of the audio is likely to be unusable as a record of speech (that is, the portion is unintelligible or untranscribable) in audio recordings of human speech. Real-time error alerting, or error marking in real-time or near real-time, of likely unusable portions of audio input allows participants to rerecord likely unusable portions into the original recording while memory is fresh and parties are available and easily accessible.

Audio recording is frequently used to maintain a record of human speech. As a few examples, courts may use electronic recording (“ER”) to record proceedings, entity governing bodies (such as corporate boards or local government committees) may use ER or video with audio to record meetings, and police or other emergency personnel may use body-worn cameras (“BWC”s) to record statements of witnesses and suspects.

One key, and long unsolved problem, in using audio recording of speech for recordkeeping (“ARSRK”) purposes is that audio recording devices do not indicate whether the audio input is likely to be unusable as a record of the speech therein. (That is, the speech as recorded may be unintelligible or untranscribable.) The need to review the record may arise months or years later, and if the recording is not transcribed or listened to prior to need arising, unusability will not be detected prior to the need to use the record. As participants may become unavailable or not recall content, the recording (and therefore the record) may become entirely unusable; even missing small, but pivotal, sections may result in significant and costly disputes.

The present invention solves this problem by alerting, in real-time, or marking, in real-time or near real-time, audio input sections likely to be unusable as a record of speech. The present invention dispenses with the need to have a non-participant human (such as, in the example context of a courtroom, a certified shorthand reporter, stenographic reporter, or voice reporter) monitor the quality of the audio input.

Three general types of art are known and relevant yet teach away from the present invention: First, audio alerts and markers for anomalies, which assist with detecting and correcting all types of errors, do not consider usability of speech. Second, speech-to-text (“STT”) transcription may facilitate transcription, but does not alert when its input is likely to lead to failed transcription or errors in transcription. And third, human-user-interfaces for detection and correction of errors necessitate human interaction with the input, as opposed to automatically alerting to error and encouraging rerecording.

Regarding the first category, alerts and markers which indicate anomalies in an audio recording are known in the art, but these alerts and markers do not distinguish between anomalies that render the audio unusable and anomalies that merely diminish the quality of the audio. The art teaches toward identifying the type of error and correcting it, rather than identifying the likely effect of the error and prompting the participants to review and rerecord.

As one example, peak meters and root-mean-square (“RMS”) algorithms, long known in the art of audio recording and processing, may be used to detect that an audio signal is excessively strong and likely subject to distortion, popping, clipping, or similar errors. However, the mere presence of these errors does not establish that human speech captured in an audio input would not be recognizable or transcribable by a later listener. Excessive error marking leads to inefficiencies owing to unnecessary interruptions of the recording, excess delay in processing time, and unnecessary duplicative rerecording, so the mere use of these methods is insufficient for present purposes.

As a more recent example, U.S. Pat. No. 7,319,762 (Bianchi, et al.) teaches a method of identifying and correcting sound overload. However, there is no need to identify or correct sound overloads in ARSRK unless the overload will result in unusability. Again, using this method would result in excess error alerting or labeling and is therefore undesirable and counterproductive.

U.S. Pat. No. 9,135,952 (Duwenhorst et al.) teaches a method for semi-automatic audio problem detection and correction. However, this method also is concerned with identifying the type of error and correcting, thereby maximizing improvements in quality, as opposed to simply identifying unusable portions and rerecording those. Similar to the immediately preceding methods, use of this method would result in excess error alerting or labeling and is therefore undesirable and counterproductive. (Moreover, that patent involves a user interface for correction, as opposed to an alert to suggest re-recording part of the audio input, and therefore the inefficient use of an additional human, discussed further below.)

Regarding the second category, the ability to use STT (sometimes also referred to as automatic speech recognition or ASR) to transcribe audio is known in the art. However, STT methods are only as reliable as the quality of data they receive. The present invention therefore can function alongside and in supplement to STT models to indicate that raw, or processed, audio, is not suitable for STT and likely to lead to STT errors, without need for human review of STT transcriptions for actual errors.

Currently, STT uses confidence scores to indicate how similar input is to training data. However, confidence scores' ability to indicate usability are severely limited by (1) the quality of training data and (2) the lack of an established correlation between low confidence and low usability. STT models have been trained to recognize spoken words, and to distinguish noise from speech, but no known STT models focus on distinguishing speech that is usable from that which is unusable. Therefore, known STT models' confidence scores show a low correlation to usability. Even if an STT is trained on both usable and unusable speech, a low confidence score does not necessarily correlate to low usability; i.e., a new word (such as technical vocabulary), unique name, or accent can trigger a low confidence score yet a human observer may find the new word, unique name, or accent intelligible and easily transcribable, even if only in a phonetic manner. Therefore, STT confidence scores alone are likely not sufficient for detecting unusability.

Some ASR models, typically combined with digital assistants or automated menus, have used confidence scores to indicate when input does not match a certain limited universe of known input possibilities (accepted commands, such as “Hey [assistant], play [band/music type]”). However, usage of confidence scores to signify that speech does not match a limited set of commands has very limited, if any, application when attempting to determine usability of speech generally for transcription.

Regarding the third category, both STT (potentially including confidence scores) and anomaly alerts and markers may be coupled with user interfaces to allow for monitoring and correction of the audio. However, participants are generally unsuitable monitors because their attention is focused on producing or understanding the audio (i.e., interacting with other participants, asking questions, giving statements, or listening). Therefore, an invention which eliminates the need to obligate an additional human monitor/corrector/editor is beneficial.

### DESCRIPTION OF THE INVENTION

The invention is a method for identifying unusable (unintelligible or untranscribable) portions of audio recordings of human speech and alerting the human participants to the recording in real-time, or marking unusable portions in real-time or near real-time.

Alternatively or in addition, the invention may mark recorded portions of audio input as unusable for transcription.

In some embodiments, the audio input is transmitted over a network prior to classification. The method of classifying and alerting or marking described in this invention, or article embodying the same, may be stored at another site. The audio input may be transmitted via long-range transmittal methods such as radio, wifi/ethernet/internet, or short-range transmission methods such as Bluetooth.

In some embodiments, the audio input may be subject to various data preprocessing steps prior to analysis. For example, a waveform may be transformed into a spectrogram via the Fourier Transformation or modifications thereof. Further feature extraction via spectral centroid, falloff, bandwidth, or other calculations may also assist in isolating relevant portions or extracting relevant features of the audio input.

In differing embodiments, the method of classification regarding usability may use artificial intelligence (“AI,” sometimes also referred to as machine learning or “ML”) models, comparison to known values, or algorithms. These different methods of classification may be used alone or in conjunction. Known values may include minimum and maximum input values, and peak values. Algorithmic models may include comparison of any two or more data points including known values, extracted features, or any combination thereof. Where AI models are used, the AI models are trained using training and test data sets prior to deployment. However, the AI models may continue to improve by using real data, and user feedback, after deployment.

In some embodiments, the invention alerts using a visual or audio cue, or both, perceivable by the human participants. The visual cue could be a change in color, a light turning on or blinking, or a similar alert apparatus. The audio cue could be any audible noise including a beep, siren, “untranslatable” or “error” message via machine-generated speech, or similar alert apparatus.

In some embodiments, the unusable audio input may be marked by a timestamp output (with beginning and ending timestamp(s) indicating the start and end of the unusable section(s)) or highlighting or otherwise visually distinguishing one or more portions of a waveform file. Output here may refer to a display of values, a printed sheet, or simply storing the timestamp values as data in a file.

In some embodiments, wherein a textual output of transcribed speech is produced, error marking may be accomplished through visually distinct markings (such as highlighting, italicizing, underlining, or changing the color of text) applied to the likely unusable text.

In some embodiments, the invention rewinds the audio to a section prior to the unusable portion and plays back the last usable portion so that participants can recall the context and content prior to the unusable portion and more easily rerecord the unusable portion of the audio.

In some embodiments, the method of classifying and alerting is stored in an article using one or more microprocessors.

What is claimed is:

1. A method to alert to one or more human participants in an audio-recorded session that a portion of the audio being recorded is unusable for record-keeping purposes (unintelligible or untranscribable), or to alternatively mark a portion of recorded audio as unusable (unintelligible or untranscribable), comprised of:
a. extracting one or more features from the recorded audio;
b. determining the likelihood of usability of the audio for record-keeping purposes (intelligibility or transcribabilitiy) and classifying it as likely usable or likely not usable; and
c. when the audio is likely unusable, (i) emitting an alert, (ii) marking the unusable portion, or (iii) both.

2. The method of claim 1, wherein the alert signal is an audio alert.

3. The method of claim 1, wherein the alert signal is a visual signal.

4. The method of claim 1, wherein the mark of the unusable portion consists of a timestamp output.

5. The method of claim 1, wherein the mark of the unusable portion consists of highlighting a visual portion of a waveform in a file capable of generating a visual waveform.

6. A method of facilitating re-recording of an unusable portion of audio comprised of the method of any of claims 1-5, further comprising automatically rewinding the recording to an usable portion sufficiently prior to the unusable portion that a human participant can identify the context and the unusable portion and playing back the last usable portion before resuming recording.

7. An article embodying any of claims 1-5, using one or more microprocessors.

8. An article embodying claim 6, using one or more microprocessors.
